(19) United States
(12) Patent Application Publication
(10) Pub. No.: US 2009/0300161 A1
(43) Pub. Date: Dec. 3, 2009

(54) Method and system for using feedback in accessing network services

(75) Inventors: Joseph A. Pruitt, Sammamish, WA (US); Gary N. Mager, Seattle, WA (US)

Correspondence Address: Nixon Peabody LLP (F5 PATENTS);Gunnar G. Leinberg, 1100 Clinton Square, Rochester, NY, 14604, US

(73) Assignee: F5 Networks, Inc.

(21) Appl. No.: 10/717,698

(22) Filed: Nov. 20, 2003

(51) Int. Cl. G06F 15/173; G06Q 10/00; G06Q 50/00; G06F 15/16

(52) U.S. Cl. 709/224; 705/7; 709/226

(57) ABSTRACT

A method and system for providing or utilizing feedback information in accessing network services. In one embodiment, a client requests a set of one or more service locations for service providers from a directory service. The directory service provides the set. The client then selects a service provider and initiates a transaction. Feedback data regarding the transaction is then collected for use in providing or selecting service providers, or in improving the directory service processes.

### FIELD OF THE INVENTION

This application relates generally to computer services, and more specifically to accessing network services.

### BACKGROUND

Universal Description, Discovery and Integration (UDDI) provides a protocol for providing a requestor of a service location with one or more service locations. A service location is an address, text string, or data that identifies or locates a service provider. A service location may include one or more of a network address, e.g., an Internet Protocol (IP) address of 122.233.22.1, a domain name such as www.uspto.gov, a port number, e.g., 2343, a path name such as /bookinventory/scientific, a network protocol, and an email address. One example of a service location is http://www.uspto.gov:2243/bookinventory/scientific. Another example of a service location is scientificbooks@uspto.gov. A Uniform Resource Identifier (URI) may qualify as a service location. A syntax for URIs may be found at http://www.ietf.org/rfc/rfc2396.txt.

In the UDDI model, service locations are published in a UDDI registry or database. Additionally, information about the service, such as which protocols the service uses may also be placed in the UDDI registry. At the time of the writing of this application, a published specification of UDDI version 3.0 dated Jul. 19, 2002, may be found at http://uddi.org/pubs/uddi v3.htm.

In the UDDI model, a client requests a location of a service provider from a UDDI server. The server then queries the UDDI registry to map the client request to a service location. Then, the server returns a service location to the client. Typically, the client then uses the service location to access the service provider.

### BRIEF DESCRIPTION OF THE DRAWINGS

FIG. 1 is a block diagram representing an exemplary traffic manager;

FIG. 2 is a block diagram representing an exemplary environment in which the invention may be practiced;

FIG. 3 is a flow diagram illustrating an exemplary process in which a directory service provides one or more service locations in response to requests for a service location;

FIG. 4 is a flow diagram illustrating an exemplary process in which a request for a service location is mapped to one or more service locations;

FIG. 5 illustrates an exemplary process of collecting feedback data from various collectors, corresponding to block 320 of FIG. 3;

FIG. 6 is a flow diagram illustrating an exemplary process in which a service provider automatically modifies its attributes based on request results;

FIG. 7 is a flow diagram illustrating an exemplary process in which a service provider automatically modifies its attributes based on feedback provided to the service provider;

FIGS. 8-10 are block diagrams representing exemplary systems embodying aspects of the invention;

FIG. 11 is a block diagram representing an exemplary system wherein feedback can be shared among clients;

FIG. 12 is a block diagram representing an exemplary system wherein feedback can be shared between directory services;

FIG. 13 is a flow diagram illustrating an exemplary process in which a directory service provides one or more service locations in response to a request for a service location; and

FIG. 14 is a flow diagram illustrating an exemplary process in which a data collector on a service provider sends feedback data directly to a directory service.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments can be utilized, and other changes can be made, without departing from the spirit or scope of the present invention. The following detailed description is, therefore, not to be taken in a limiting sense, and the scope of the present invention is defined by the appended claims.

Throughout the specification and claims, the following terms take the meanings explicitly associated herein, unless the context clearly dictates otherwise.

The term “or” is an inclusive “or” operator, and is equivalent to the term “and/or”, unless the context clearly dictates otherwise.

The term “based on” is not exclusive and allows for being based on additional factors not described, unless the context clearly dictates otherwise.

The term “network” includes any method or medium for transmitting information from one device to another, unless the context clearly dictates otherwise. A network may interconnect devices that are relatively local to each other (sometimes referred to as a local area network), devices that are relatively spread out with respect to each other (sometimes referred to as a wide area network), or some combination thereof. A network may include wired or wireless communication links. A widely recognized network is the Internet which connects millions of devices around the world.

The term “service” describes specific business functionality exposed by an organization or person, usually through an Internet connection, for the purpose of providing a way for another organization, person, or software program to use the service. Services may be used for electronic commerce. For example, one company may call another's service to send a purchase order directly via an Internet connection. Another example is a service that calculates the cost of shipping a package of a certain size or weight a specified number of miles via a specific carrier. A service can be exposed in a network other than the Internet.

U.S. patent application Ser. No. 10/431,394, entitled “Method And System For Accessing Network Services” (hereinafter “previous application”), assigned to the assignee of the present invention includes other terms and information and is hereby incorporated by reference in its entirety. To the extent that a definition of a term in the previous application contradicts a term defined in this application, the definition found in this application will control.

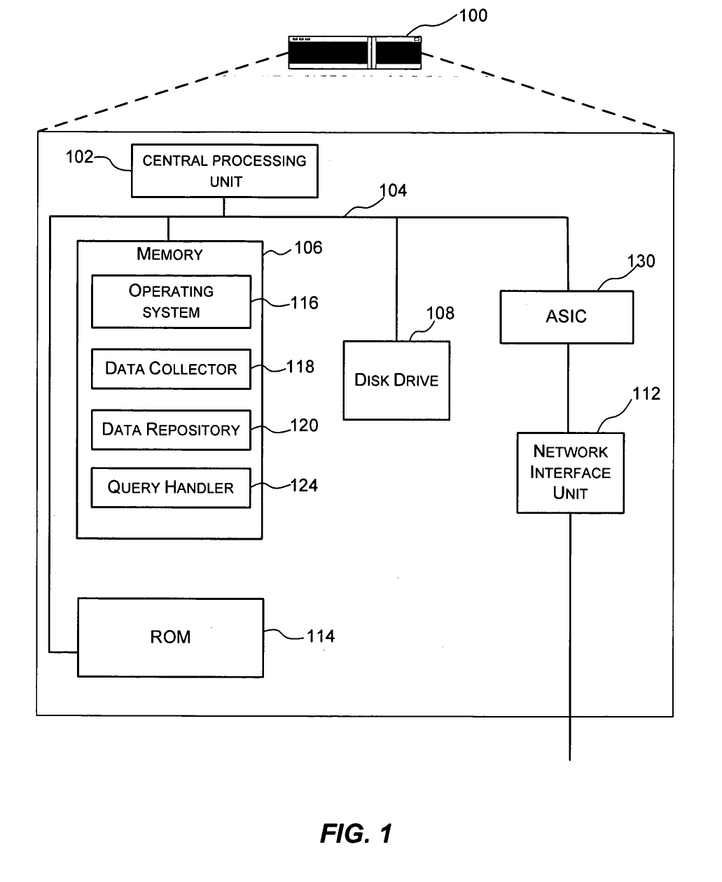

FIG. 1 is a block diagram representing an exemplary network device 100 that can operate as a data collector/data repository in accordance with an embodiment of the present invention. It will be appreciated that not all components of network device 100 are illustrated, and that network device 100 can include more or fewer components than those shown in FIG. 1.

As illustrated in FIG. 1, network device 100 includes a central processing unit (CPU) 102, mass memory, and a network interface unit 112 connected via a bus 104. Network interface unit 112 includes the necessary circuitry for connecting network device 100 to a network (not shown), and is constructed for use with various communication protocols, including the TCP/IP protocol. Network interface unit 112 can include or interface with circuitry and components for transmitting messages and data over any network, including those with a wired or wireless communication links.

The mass memory generally includes random access memory (“RAM”) 106, read-only memory (“ROM”) 114, and one or more permanent mass storage devices, such as hard disk drive 108. The mass memory stores operating system 116 for controlling the operation of network device 100. The operating system 116 may comprise an operating system such as UNIX®, LINUX®, or Windows®.

RAM 106 may include software instructions that when executed operate as a data collector 118, a data repository 120, a query handler 124, or any combination thereof. The query handler 124 receives queries from data repositories or other devices or processes and responds by providing feedback data. Data collectors and data repositories are described in more detail below.

In one embodiment, the network device 100 includes one or more Application Specific Integrated Circuit (ASIC) chips 130 connected to the bus 104. The ASIC chip 130 includes logic that performs some of the functions of network device 100. In one embodiment, the network device 100 includes one or more field-programmable gate arrays (FPGA) (not shown), instead of, or in addition to, the ASIC chip 130. A number of functions of the network device can be performed by the ASIC chip 130, by an FPGA, by the CPU 102 with the logic of program code stored in mass memory, or by any combination of the ASIC chip, the FPGA, and the CPU.

Computer storage media can include volatile and nonvolatile, removable and non-removable media implemented in any method or technology for storage of information, such as computer readable instructions, data structures, program modules or other data. Examples of computer storage media include RAM 106, ROM 114, EEPROM, flash memory or other memory technology, CD-ROM, digital versatile disks (DVD) or other optical storage, magnetic cassettes, magnetic tape, magnetic disk storage or other magnetic storage devices, or any other medium that can store the information and that can be accessed by a computing device.

Network device 100 can also include an input/output interface (not shown) for communicating with external devices or users.

Network device 100 can be implemented as one or more “blades” where the term “blade” refers to one of multiple electronic circuit boards or cards that are installed in a hardware chassis with a backplane. An exemplary blade can include one or more processors, volatile and non-volatile memory, interfaces suitable for communicating information to and from the blade, and other components for enabling the operation of one or more applications. A blade can also include a specialized interface for the backplane and other interfaces, such as a USB port, FIREWIRE port, serial port, RF interface, IR interface, Ethernet interface, IDE controller, and the like. An application running on a blade can employ any of these interfaces to communicate information to other applications running on other blades or devices coupled to the blade server. Network device 100 can also be implemented as a combination of blades and additional components in chassis.

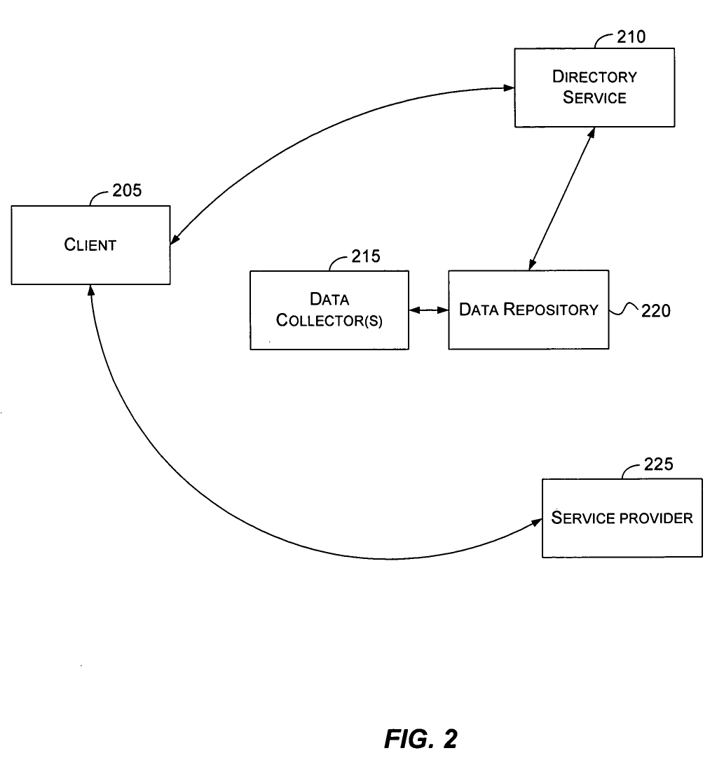

FIG. 2 is a block diagram representing an exemplary environment in which the invention may be practiced. The environment includes client 205, directory service 210, data collector 215, data repository 220, and service provider 225.

Data repository 220 comprises a data store that stores feedback with respect to one or more transactions between one or more clients, including client 205, and one or more service providers, including service provider 225. Data repository 220 may reside on client 205, directory service 210, service provider 225, a separate device or devices, or some combination of the above. Data repository may be stored as a flat file, in an eXtensible Markup Language (XML) document, in a relational database, e.g., a database accessible through a structured query language (SQL), in an object-oriented database, or in any other data format.

Data collector(s) 215 comprise any devices or processes that receive feedback data and provide the feedback data to data repository 220. Data collector(s) 215 receive feedback data with respect to one or more transactions between one or more clients and one or more service providers, such as client 205 and service provider 225. Data collector(s) 215 may reside on client 205, directory service 210, service provider 225, on a separate device or devices, or be distributed on some combination of the above.

In one embodiment, data repository 220 is implemented as part of a protocol, such as the HTTP protocol. The feedback data may be stored by a client, and passed to a directory service, as part of an HTTP cookie or other HTTP data. The feedback data may be transmitted within one or more name-value pairs within the HTTP protocol or another protocol. A structured language, such as XML, can be used for storing or transmitting feedback data.

In one embodiment, data repository 220 is implemented as a database accessible by a query language such as SQL. Additional mechanisms for implementing data repository 220 can also be used in accordance with the present invention.

Directory service 210 comprises any device or process that receives and responds to one or more requests for a service location. After receiving a request for a service location, directory service 210 determines which service location or locations to return based on data or rules stored internally or elsewhere. Such data may include feedback stored on data repository 220. Directory service 210 may comprise a UDDI server together with a component for determining the service location or locations to return based on feedback data.

Client 205 comprises any device or process that requests or uses a service. In some embodiments of the invention, client 205 comprises a server, a proxy, or some other intermediate device that requests service locations on behalf of itself or another client. After receiving a list of service locations from server 205, typically, client 205 then selects one of the service locations from the list and accesses the service at the service location.

Service provider 225 comprises any device, process, or entity that provides a service. Service provider 225 receives a request for a service from client 205. Service provider 225 may provide information that informs directory service 210 of the characteristics of the service provided by service provider 225. Service provider 225 may prioritize service processing based on feedback data.

Client 205, directory service 210, data collector 215, data repository 220, and service provider 225 may each be implemented on or by any device capable of executing instructions. Such devices may include, for example, computers, network appliances, multiprocessor systems, microprocessor-based or programmable consumer electronics, network PCs, cell phones, smart phones, pagers, radio frequency (RF) devices, infrared (IR) devices, CBs, personal digital assistants (PDAs), POCKET PCs, wearable computers, integrated devices combining one or more of the preceding devices, and the like. Network device 100 of FIG. 1 is one example of such a device. Unless indicated otherwise, each of the devices or processes mentioned in this disclosure may be implemented on or by any device capable of executing instructions as described above. Service provider 225 may comprise an individual who assists in or provides all or part of a service. For example, communications between client 205 and server provider 225 may be sent via voice over IP (VOIP) through a gateway that connects client 205 to a human who assists in or provides all or part of a service.

In requesting a service location, client 205 may include with its request any combination of client preferences, client characteristics, and feedback data from a prior transaction with one or more service providers

Client preferences may include attributes of the service or delivery of the service. These attributes can include, for example, cost of service, speed of service, quality of service (QoS), response time, freshness or accuracy of data on service, reliability of service, bandwidth, and latency, undesirable service providers, favorable service providers, and the like. Generally, client preferences are specified by the client, an application on the client, or a user utilizing the client. Client preferences may be stored on the client and transmitted when requesting a service location or they may be stored on a server. When stored on a server, a client address or ID may be used to access the client preferences. Client preferences may include a weighting or rank assigned to each of a number of attributes.

Client characteristics may include client hardware, software, and network configurations, client location, identification, and affiliations, and client system capacities. Client hardware configuration may include brand, e.g., Compaq, Dell, etc., model number, CPU, RAM, disk space, and the like. Client software configuration may include operating system, applications available on the client, the software that is requesting the service, applications currently executing on the client, and the like. Client network configurations may include bandwidth limitations, network connection information, and the like. Client location, identification, and affiliations may include geographical or topological location, data describing or identifying the client (e.g., user name, password, real name, social security number, and the like), or a user, organization, or other entity operating, owning, or otherwise associated with the client. Client system capacities may include compression capabilities, bandwidth capabilities, or other characteristics of client 205.

Feedback data describes data pertaining to a transaction, a party of a transaction, or the infrastructure involved in a transaction. Feedback data is unknown to the party providing the feedback data prior to beginning a transaction. Feedback data becomes known to a party of a transaction, or is determined by the party, as a result of information obtained during or subsequent to one or more transactions. Characteristics advertised by the service provider are not considered to be feedback data. For example, advertised response time, as provided by a service provider, is not considered to be feedback data. Actual response time based on one or more transactions is considered to be feedback data. Variation of actual response time from advertised response time is also considered to be feedback data. Variations of actual service provider data from advertised data can be considered to be feedback data. In some situations, a particular type of feedback data is subject to different evaluations depending on the entity performing the evaluation. For example, the evaluation of a quality of a service provider's service may differ based on the client, and different clients engaging in a transaction with the same service provider can each have different feedback data.

Feedback data may include connection characteristics, service characteristics, or satisfaction information. Connection characteristics may include measured latency, network path used for the connection, bandwidth, response time, dropped packets, and the like. Service characteristics may include timeliness of service (e.g., actual time for completion of a transaction), time spent requesting or negotiating the transaction, resources used in obtaining the service. Satisfaction information may include evaluative data that indicates the adequacy of the provider's products or services to a client's need, suitability of the provider to the client, the service provider's willingness to provide future service for the client, abuse of service, and the like. In all of these cases, the data is feedback data when it is data that is not known until after the transaction begins.

Feedback data can be classified according to the entity providing the feedback data. Client feedback data is data not known by the client prior to the transaction that becomes known to the client during or subsequent to the transaction. Actual response time, connection characteristics, and satisfaction with the provided service or products, suitability of the provider to the client, and variations from expectations, when provided by a client, are considered types of client feedback data.

Another classification of feedback data is service provider feedback data. Service provider feedback data is transaction related data provided by a service provider, where the data is not available prior to the beginning of a transaction. A service provider may indicate a client's reverse trace route, a client's usage of the service provider (e.g., frequency of requests or abuse of service), the service provider's willingness to provide future service for the client, information about the connection between the service provider and the client such as dropped packets, bandwidth characteristics, and the like, or data that identifies the service provider. This may be useful, for example, in helping the directory service determine which service provider a client chose from the service locations returned to the client.

Third party feedback data is feedback data provided by a device that is not a client or a service provider. It may be from a device that merely observes at least part of the transaction. It may also be from a device that acts as an intermediary network device during the transaction, such as a proxy server, traffic manager, router, or other intermediary network devices. Directory service feedback data is third party feedback data provided by a directory service. This includes data such as the scoring or ranking determined by the service provider in response to a client request.

Feedback data may be automatically collected, manually indicated, or some combination thereof. For example, a data collector may automatically capture the response time of each service provider. A data collector may automatically collect information that indicates that a transaction has started, completed, or been cancelled. For a cancelled transaction, or a transaction where a client controls the length of the transaction, the duration of the transaction can also be collected.

In addition to collecting data, a data collector can process collected data to enhance the feedback data. One example of this is processing that occurs when a client cancels a transaction. The client cancellation and the timing of the cancellation are types of feedback data that can be automatically collected. A data collector can process cancellation data to generate enhanced feedback data. A client cancellation correlated with elements of a transaction, or one or more other types of feedback data can indicate the degree to which the transaction elements or other feedback data are unacceptable. For example, a service provider might advertise an estimated price or response time. During the transaction, a client might become aware of a different actual price or response time. A cancellation by the client immediately after becoming aware of the difference can indicate to a data collector that the difference is not acceptable to the client, even without receiving this feedback directly from the client.

In one type of feedback, a client can cancel a transaction based on a status of a second transaction, possibly with a different service provider. For example, a client can initiate two similar transactions each with a different service provider. Upon receiving a satisfactory response or complete transaction with one of the service providers, the client might cancel the transaction with the second service provider. In this case, the timing of the cancellation in relation to both transactions serves as feedback indicating a preference for the first service provider based at least on response time. The client can also provide explicit feedback that it prefers the first service provider over the second based on response time. A similar process can occur if one service provider provides a partial or complete response with a cost estimate or service quality that is inferior to a second service provider, and the client cancels the inferior service provider. Cancellation in this respect can be an explicit cancellation or merely discontinuing the transaction.

The above process can be extended to obtain feedback data by comparing two or more service providers. An entity, which can be a client, a directory service, or a data collector, can initiate comparable transactions with two or more service providers, either concurrently or sequentially. The results of the transaction are then compared to provide comparison feedback related to the participating service providers. This comparison feedback is then used for subsequent decision-making for selection of a service provider. A data collector can monitor the feedback data it has, and perform, or request another device to perform, such comparisons when it needs fresh feedback data. In one application of the invention, a client or other entity, anticipating a need for a service, performs one or more sample transactions with one or more service providers and uses feedback data resulting from the sample transactions to improve selection of a service provider for a subsequent transaction.

A client may be automatically asked for feedback regarding a transaction after the transaction has completed or terminated. A client may automatically store data regarding each transaction. A data collector may query the client for this data. A data collector may ask a client to provide user feedback regarding one or more transactions with a service provider. In some embodiments, at least a portion of the feedback is provided manually by a person. For example, a user using the client may provide text or may fill out a form that indicates the user's experience with the service provider. A client or other entity may also automatically send feedback data to a data collector without receiving a request for the data.

In some embodiments, a data collector and data repository retrieves and stores feedback data provided by each client, service provider, or other entity independently of feedback data of other entities. In some embodiments, feedback data is aggregated either when storing the data or when retrieving it. In some embodiments, combinations of aggregated and individual data may be maintained and retrieved. Aggregating feedback data relating to a service provider may, for example, allow a directory service to determine whether actual response time is consistently worse than advertised response time or how satisfied clients are with a particular service provider. Aggregate feedback data also allows a client that has not previously transacted with a service provider to use data pertaining to the service provider.

Feedback data may be stored or collected in a manner to preserve client privacy. In some embodiments of the invention, information identifying the client or service provider that provided the feedback is not collected. In other embodiments of the invention, identifying information is collected but not stored. In other embodiments of the invention, identifying information is collected and stored in such a way that it is obfuscated (e.g., through encryption, hashing, or otherwise). In yet other embodiments of the invention, identifying information is stored while access to the information is restricted to authorized entities. Some embodiments of the invention combine one or more of the embodiments described above.

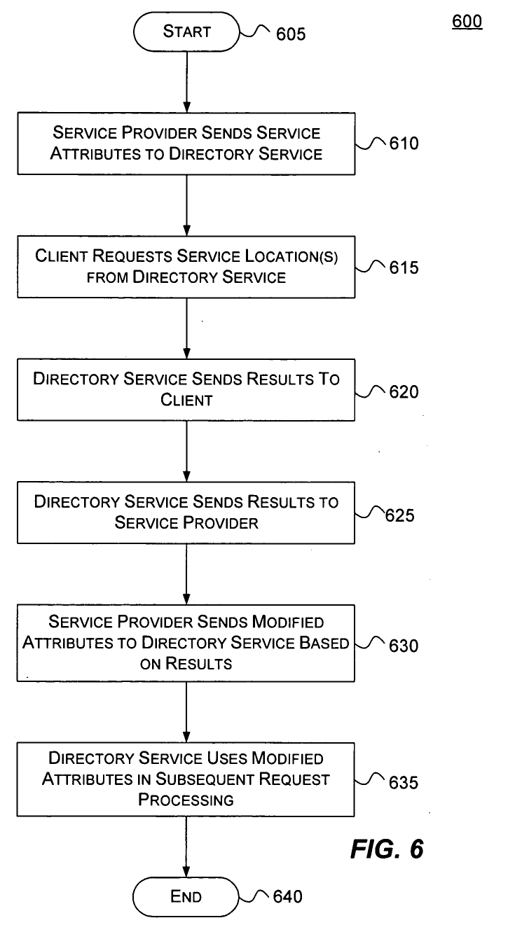

Feedback data may be used by a directory service, a client, or a service endpoint. A directory service may use feedback data to determine which service locations to send to a client. A client may use feedback data (e.g., from other clients or otherwise) to determine which service location to select. A service location may use feedback data to automatically adjust characteristics of the service (e.g., price, quality, or response time). For example, a service location may inform a directory service that the price of a service has changed or that users may expect a better response time. This is discussed in further detail in FIG. 6 and the associated text.

Each entity using feedback data may determine how much weight to give to each portion of the feedback data. Some feedback data may be weighted more heavily than other feedback data. For example, feedback data from a client that has a high feedback/request ratio (and a significant number of feedback responses) may be given more weight than data from a client that has transacted with many service providers but has only provided feedback data once. Feedback data from one client that transacts with one or more services that is consistently different from feedback from other clients that have transacted with that service may also affect how much weight feedback from the client is given. Feedback data from a service provider for which most clients indicate a good experience may be given more weight than feedback data from a service provider that is new or that has low experience ratings from clients.

Directory service 210 may make a determination as to which service locations to return to a requesting client based on information including data sent from the client, data derived or located via data sent from the client, or feedback data. In determining which service locations to return to a client, directory service 210 may request more data from the client. For example, some service providers may only be willing to provide a service if they are given a client's phone number. There is no need to give locations of such service providers to a client should the client not be willing to provide the phone number. In a request, a client may indicate a preferred service provider. A directory service may know that the client's preferred service provider is no longer available. The directory service may respond to the client's request and ask for another preferred service provider. The directory service may also indicate to the client that the client's former preferred service provider is no longer available. The client may then update any data it has to reflect that the service provider is no longer available.

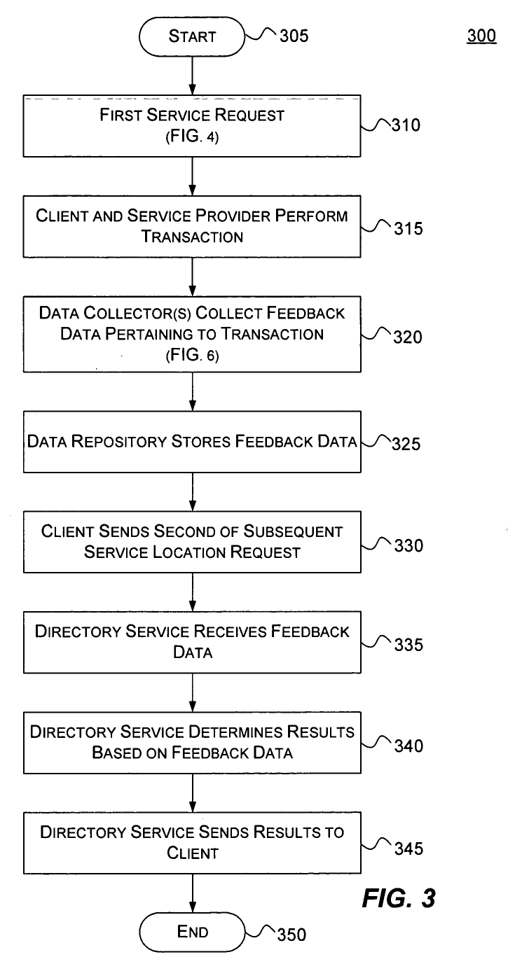

FIG. 3 is a flow diagram illustrating an exemplary process 300 in which a directory service provides one or more service locations in response to requests for a service location. As illustrated in FIG. 3, the process begins at block 305.

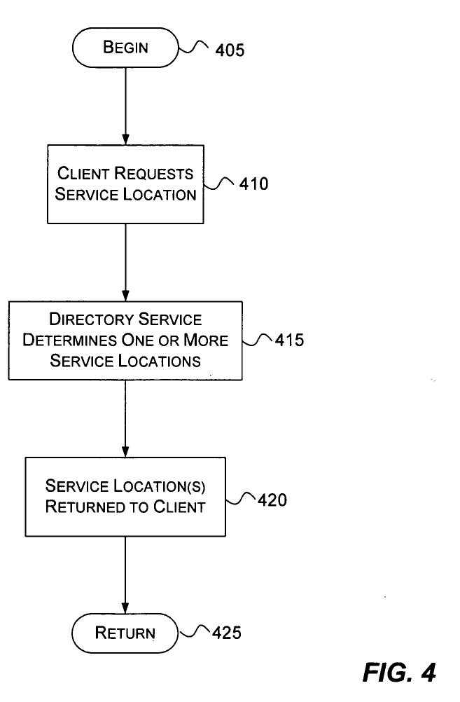

At block 310, a first service request is received and responded to as described in more detail in conjunction with FIG. 4. In responding to a service request, a directory service may send a data object that includes information readable or writable by the client, information readable or writable by the service provider, information readable or writable by the directory service, or some combination thereof. In some embodiments of the invention, one or more of the service provider, the directory service, and the client are prevented from or do not write to or read from the data object. In some embodiments, encryption, hashing, or digital signatures can be used to prevent an entity from reading or modifying such information.

In another embodiment of the invention, the client first passes the data object to the directory service. The directory service then reads or writes to the data object and sends the data object back to the client together with the one or more service locations. A data object, as used in this document, includes one or more bits and is fixed or unfixed in length. A data object may grow, contract, or remain the same size. Any kind of information represented or readable by a computer system can be stored in a data object. A data object may also include computer-executable code that is invoked through methods of the data object or otherwise.

At block 315, the client and service provider engage in a transaction. During or before the transaction, the client may indicate or choose the service desired, together with any client preferences or client characteristics. In some embodiments of the invention, the client also passes the data object into which the service provider may place information, such as feedback regarding the transaction.

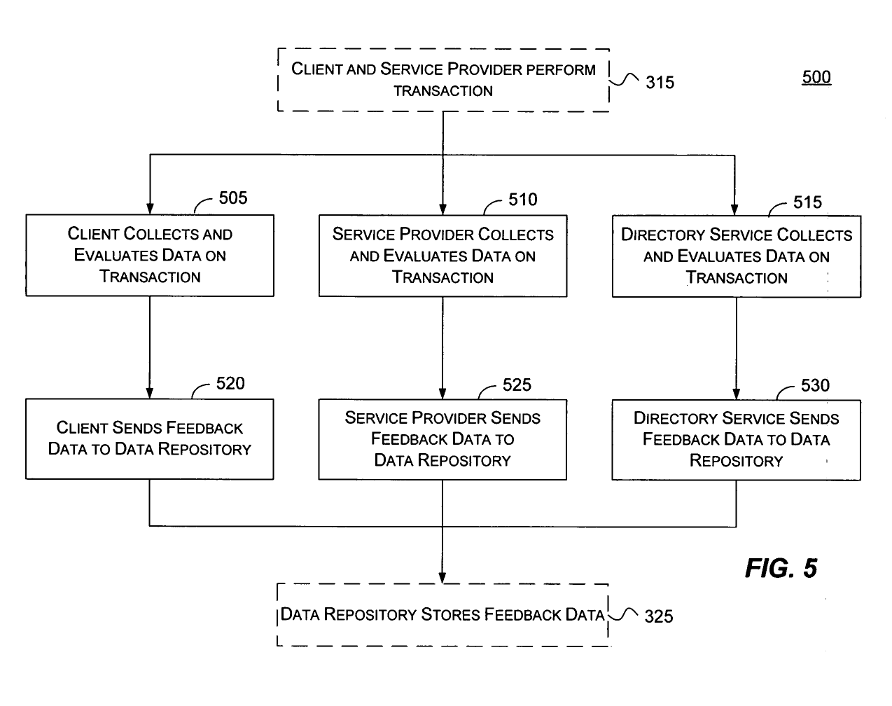

At block 320, one or more data collectors collect feedback data pertaining to the transaction. As described previously, data collectors may reside on the client, on a service provider, on a directory service, on another device or devices, or some combination thereof. FIG. 5 illustrates a process 500 of collecting feedback data by various collectors, corresponding to block 320 of FIG. 3. Blocks 315 and 325 from FIG. 3 are repeated in FIG. 5 to show the steps preceding and following collecting data from the various data collectors.

At block 325, the feedback data is stored in a data repository. As mentioned previously, the data repository may reside in one location or may distributed over the client, the directory service, the service provider, another device or devices, or some combination thereof.

At block 330, a client sends a second service location request. This client can be the same client involved in the actions of blocks 310-325, or it can be a different client. The request can be for the same type, or a similar type of service as that requested and transacted at blocks 310 and 315, or it can be for a completely different type of service.

At block 335, the directory service receives feedback data. The feedback data may be received as the client passes back a data object to the directory service, or it may be retrieved from some other data repository.

At block 340, the directory service determines which service locations to return based on the feedback data. A determination of which service locations to return based on feedback data is described in more detail in conjunction with FIG. 4. The directory service then sends these service locations to the client at block 345. After receiving a set of one or more service locations, the client can select one or more and perform the desired transactions. During this selection process, the client might also use some portion of the available feedback data. At block 350, the process ends.

The process shown in FIG. 3 may be executed each time a client makes a first and subsequent service request. After the first request for a service (and subsequent feedback regarding the service or client is collected) from any client, in response to another request for the service location or another service location, a directory service may make a determination as to which service location or locations to return based on the feedback data collected. The feedback data that is used in the determination may be from one or more prior transactions.

FIG. 4 is a flow diagram illustrating an exemplary process in which a request for a service location is mapped to one or more service locations. The process will be described together with an exemplary embodiment of interactions among the components in FIG. 2. The process shown begins at block 405 when a client is ready to request a service. After block 405, processing continues at block 410.

At block 410, the client requests a service location. As discussed above, the client request can include client preferences, client characteristics, or feedback data from a prior transaction with one or more service providers. For example, referring to FIG. 2, client 205 requests the location of a book inventory service from directory service 210. Client 205 includes in its request that client 205 desires a service having scientific books in English or Japanese. After block 410, processing continues at block 415.

At block 415, a directory service determines one or more service locations. In an embodiment of the invention, referring to FIG. 2, directory service 210 consults a registry (not shown) that includes information about service locations and obtains a list of service locations satisfying client 205's request. Directory service 210 may also determine whether any feedback data from data repository 220 is appropriate for determining or ranking the list of service locations to return to client 205.

In one embodiment, a directory service determines a score for each service location based on feedback data, client preferences, or client characteristics. The directory service may determine a ranking for each service location by comparing the scores of a number of service locations. The scores, and therefore the ranking, based on feedback data may take into account the type of feedback data, history of a client or clients providing the feedback data, consistency of the feedback data from difference sources, and the like.

In performing a ranking calculation for a client, each weight may be particular to the client. For example, with a client that has a high preference for response time, the weighting of feedback on response time may be high. Also, feedback weights may vary based on how similar the source of the feedback is to the requesting client. Where feedback from the requesting client and other clients is available, the feedback from the requesting client may have the highest weight, feedback from clients similar to the requesting client may have the next highest weight, and feedback from other clients may have a lower weight. Similarity between clients may be based on one or more client characteristics, preferences, or feedback patterns associated with the clients. For example, clients that have previously had similar feedback data might be given a higher weight than other clients.

Feedback weight may also be based on the history of receiving feedback from a particular client. In some embodiments, clients having a higher number of feedback responses may have a higher weight associated with their feedback. This weight may have an upper limit. In other embodiments, feedback is weighted to favor feedback received from different clients, so that one client giving a high number of responses does not unduly skew a weight. Feedback weight based on number of responses and diversity of clients providing feedback may be combined.

Feedback weight may also be based on correlation or variation from aggregate feedback. Feedback with higher correlation to other feedback may receive higher weight while feedback that varies greatly may receive lower weight.

Feedback may be aged and weighted according to the freshness of the feedback. More recent feedback may receive a higher weight that less recent feedback.

A formula for scoring a service endpoint is:

$$Score = {\sum }_{n = 1}^{N} Wn * Dn * Fn$$

where Wₙ is a weighting factor corresponding to criteria n, Dₙ is a value representing the data for criteria n on a scale from 0 to 100, and Fₙ is a value representing feedback for each criteria.

Fₙ may include a range of values, such as values between 0 and 2 (or any other values), that indicates the accuracy of the corresponding Dₙ criteria, based on feedback. For example, if Dₙ represents the quality of results from the service provider, as stated by the service provider, a value Fₙ of 1.0 may indicate that collected feedback supports the accuracy of value Dₙ. An Fₙ of 0.5 may indicate either that feedback indicates actual quality is one-half of Dₙ or that the quality varies so much that even though Dₙ might be an average, it is not a good value to use. An Fₙ of 1.5 might indicate that, for example, the actual quality is higher than the value Dₙ or that it is very consistent. A high (or low) Fₙ might also indicate that the feedback from the requesting client is better (or worse) than the average value Dₙ, and so should be adjusted accordingly. So, overall, the Fₙ factor provides a way to adjust a Dₙ value to be one that is a more useful value for the requesting client.

In another implementation, there may be multiple Dₙ values corresponding to a particular criteria. A first value, Dₙ₁, might represent an average value, such as an average response time. A second value, Dₙ₂, might represent a median value, such as median response time. A third value, Dₙ₃, might represent the inverse of the amount of negative deviation from the average or median value with a higher Dₙ₃ value indicating that there is a small amount of negative deviation. In this context, negative deviation is the statistical deviation in the negative direction for the criteria. A client that is very concerned about the Dₙ criteria can have a high weighting Wₙ₁ or Wₙ₂ for the average or median value, as well as a high weighting Wₙ₃ for the negative deviation. The client might prefer a service provider with a slower average or median response time if there is less likely to be a significant negative deviation from the average or median response time.

At block 420, a list of service locations is returned to the client. In an embodiment of the invention, referring to FIG. 2, directory service 210 returns a list of service locations to client 205. This list of service locations may be ordered or ranked or may include the scores that the directory service used to order or rank the service locations. After block 420, processing continues at block 425.

At block 425, processing ends. At this point, the client may select a service location and access the service at the service location. The process shown in FIG. 4 may be repeated each time a client desires a service location.

FIG. 5 illustrates a process 500 of collecting feedback data from various collectors, corresponding to block 320 of FIG. 3. After block 315 of FIG. 3, processing continues at one or more of blocks 505, 510, and 515. At block 505, a data collector residing on a client collects and evaluates data regarding the transaction (from the client's point of view) between the client and the service provider. At block 510, a data collector residing on the service provider collects and evaluates data regarding the transaction (from the service provider's point of view) between the client and the service provider. At block 515, a data collector residing on the directory service collects and evaluates data regarding the transaction (from the directory service's point of view) between the client and the service provider. The processing in blocks 505, 510, and 515 will generally occur asynchronously with respect to each other and may proceed in parallel on each of the respective devices. The types of data and the actual data collected by each of the data collectors at the respective blocks 505, 510, and 515 might be the same data, different data, or a combination of the same type of data and different data. In a system including multiple clients, multiple service providers, or multiple directory services, redundancy in the collection of feedback data improves the overall collection of data if any clients, service providers, or directory services are not functional to collect and share some or all of the feedback data.

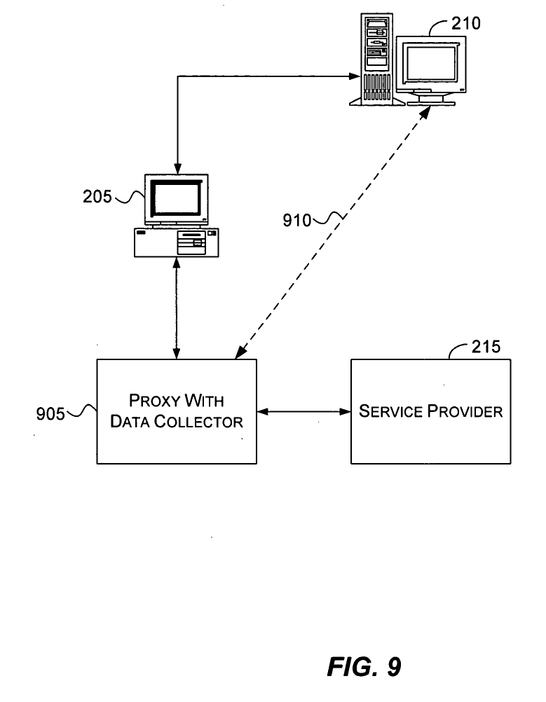

At blocks 520, 525, and 530, the data collectors on each of the client, the service provider, and the directory service, respectively, send their feedback data to a data repository. Note that the data repository may be distributed among the client, the service provider, the directory service, and other devices, or it may be a single, centralized repository. Thus, sending feedback data to a data repository may comprise sending the data to a local storage area or transmitting the data remotely across a network. After blocks 520, 525, and 530, processing continues at block 325 where the feedback data is stored in a data repository. Although FIG. 5 shows data being collected on each of the client, the service provider, and the directory service, there is no intention of limiting the invention to this embodiment; the invention can be practiced in environments having one or more data collectors in different configurations. The configurations can include having data collectors distributed among multiple devices, more than one data collector on a single device, or combinations thereof. Furthermore, in another embodiment of the invention, shown in FIG. 9, there is a data collector residing on a proxy that is located between a client and a service provider.

FIG. 6 is a flow diagram illustrating an exemplary process 600 in which a service provider automatically modifies its attributes based on request results. Request results comprise information that indicates which service providers are being selected by clients or how service providers are ranked by a directory service with respect to client preferences or other criteria included in client requests. Attributes of a service provider may include attributes related to client preferences (e.g., response time, data accuracy and freshness, cost of service), attributes related to compatibilities or suitability with client characteristics (e.g., client hardware, software, network configuration, location, identification, affiliation, and capacities), or any other criteria that a directory service may use to determine service locations or rankings of service locations to send to clients. For example, a service provider may lower its price to be more competitive or charge more if it is underbidding as indicated by the service location rankings or the percentage of clients that actually engage in or complete a transaction with the service provider.

At block 605, the process begins. At block 610, the service provider sends service attributes to one or more directory services. At block 615, the client requests service locations for a service from the directory service. The directory service determines a set of service locations based on the client request, and optionally feedback data. At block 620, the directory service sends one or more service locations to the client. At block 625, the directory service sends results information to the service provider. Results information can include data that indicates to which service locations the directory service is referring clients, the rankings of service locations by the directory service, or other data indicative of the process of determining results by the directory service. At block 630, the service provider sends modified attributes to the directory service based on the information. At block 635, the directory service uses the modified attributes in subsequent request processing. At block 640, the process ends. The process 600 may repeat at various frequencies including as frequently as each time a client requests a service location or at predefined or determined intervals.

In one variation, the directory service performs the action of sending results at block 625 prior to performing the action of sending results to the client at block 620. These results are considered to be preliminary results. In response to receiving these preliminary results, the service provider can perform the action of sending modified attributes to the directory service, of block 630. Upon receiving modified attributes from one or more service providers, the directory service might perform another determination of service location results, and send the revised results to the client, as in the block 615. In this variation, the process might include a time period that the directory service waits after sending results to the directory service. If revised attributes are received within the time period, they are used in the revised results determination. If not, the revised attributes might be discarded, or they might be used in subsequent determinations. This time period for waiting can be a very short time, such as a few seconds or less, or longer times, such as several minutes. Other time periods can also be used.

The service provider might also send, with its modified attributes, an indication of restrictions on the use of the modified results. The restriction might be based on requesting clients, and be limited to one or more such clients. The restriction might be based on time, and be limited to a specified time period. The restriction might be based on directory service transactions, and be limited to a specified number of client requests, or even to just the present client request. In one implementation, the service provider sends, along with the restriction information, a key value. The directory service passes the key value to the requesting client. The requesting client uses this key value during its transaction with the service provider to indicate that it is authorized to employ the modified attributes.

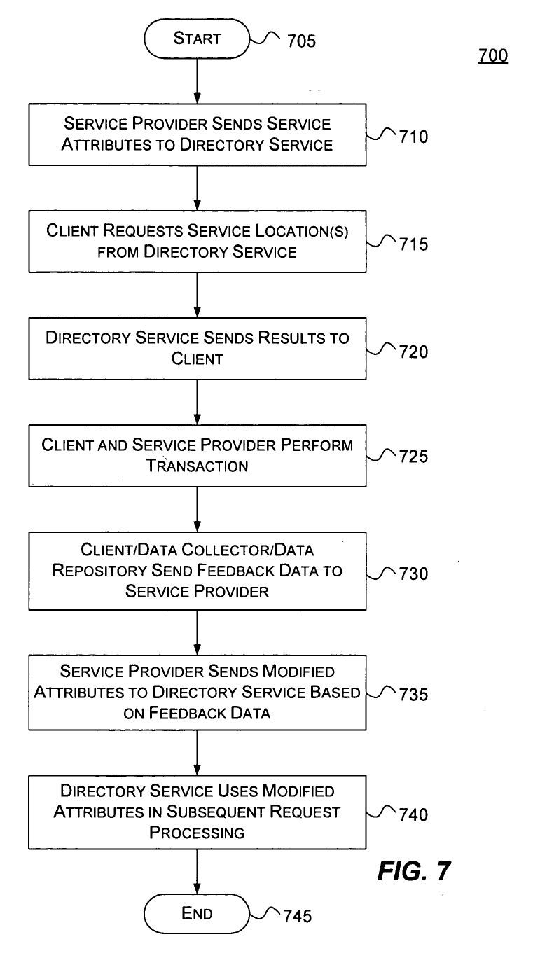

FIG. 7 is a flow diagram illustrating an exemplary process 700 in which a service provider automatically modifies its attributes based on feedback provided to the service provider. In some cases, a client (or a data collector on the client) may provide feedback directly to the service provider. The feedback may include an indication of a reason why the client did or did not complete a purchase. The feedback may include an indication of what would make the client more likely to purchase from the service provider. The feedback may include an evaluation of the attributes advertised by the service provider as compared with the attributes as perceived by the client. This evaluation may include data indicating the importance of the evaluation to the client. The client may send data to the service provider that indicates characteristics of a network connection between the client to the service provider, e.g. the latency, bandwidth, response time, and the like. In addition, or alternatively, other data collectors may send feedback to the service provider or the service provider may access a data repository to obtain the feedback. In response to the feedback, the service provider may then send modified attributes to one or more directory services in an effort to affect future decisions by the directory service.

At block 705, the process begins. At block 710, the service provider sends service attributes to one or more directory services. At block 715, a client requests service locations from a directory service. At block 720, the directory service sends one or more service locations to the client. At block 725, the client and a selected service provider engage in a transaction. At block 730, the client (or a data collector residing on the client), one or more other data collectors, or a repository send feedback data to the service provider. At block 735, the service provider sends modified attributes to the one or more directory services based on the feedback data. At block 740, the one or more directory services use the modified attributes in subsequent request processing. At block 745, the process ends. The process 700 may repeat at various frequencies including as frequently as each time a client requests a service location or at predefined or determined intervals.

As discussed above, the service provider might specify restrictions on the use of the modified attributes, and might include a corresponding key value. In one variation, the service provider might send modified attributes, and optionally a corresponding key value, to the client, with an indication that the modified attributes will apply specifically to the client in one or more future transactions or for a specified time period.

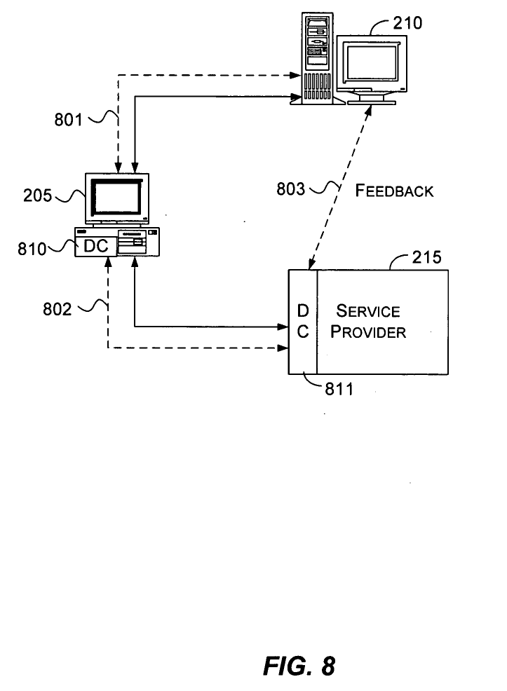

FIGS. 8-10 are block diagrams representing exemplary systems embodying aspects of the invention. The system shown in FIG. 8 includes client 205, directory service 210, and service provider 215. Client 205 includes data collector 810. Service provider 215 includes data collector 811. Dotted lines 801-803 represent feedback paths.

In one embodiment, client 205 requests service locations from directory service 210. The request may include feedback data related to one or more previous transactions in which client 205 has engaged with service providers. The request may also include feedback data related to one or more previous transactions in which a different client (not shown) has engaged with service providers. Such feedback data may be included in a data object as described in conjunction with FIG. 3.

When client 205 includes feedback data, directory service 210 incorporates the feedback data into a data repository (not shown) accessible by at least directory service 210. The data repository may also be accessible by client 205 or service provider 225.

Upon receiving the requests for a service location, directory service 210 determines one or more service locations to return to client 205 based on feedback data, if any is available, as previously described. Directory service 210 then returns the one or more service locations together with optional additional data. Directory service 210 may also return a data object as described in conjunction with FIG. 3. The one or more service locations may be ordered or ranked according to client preferences or other criteria sent by the client.

It is also possible that a directory service 210 returns zero service locations, in a situation where none match the desired criteria. Additional data returned could provide an indication of why no service locations match the desired criteria. One type of additional data could indicate that one or more specified criteria were too selective to allow a match. In response, a client might revise its criteria and send another query. Another type of additional data could indicate that the reason for returning zero service locations is temporary. In response, a client might wait for a period of time and then send another query. Heavy loads, maintenance, or other problems with one or more service providers might be a cause of a temporary non-match. Network problems, resource shortages, and other factors could also contribute to temporary inability to return selections.

The optional additional data may include directory service information (e.g., an address at which the directory service may be reached, a server certificate, and the like), a token identifying the user (e.g., a user ID, Kerberos ticket, and the like), policy information relating to the client, client history (e.g., history of providers used or request/feedback ratio of client), transactional data (e.g., data that indicates that the client should be given a special price as a first time customer of a service, data that indicates that the client should be given preferential treatment as a returning client, data that indicates that the client should be given special treatment for being part of a group, and the like) or any other data. Portions of the optional additional data may be associated with specific service locations returned to the client. For example, the client may be a first time client for one service provider, but would not necessarily be a first time client of another service provider.

Client 205 may then select one of the service locations and engage in a transaction with service provider 215. Client may send the optional additional data (or a portion of the additional data applicable to the service provider) or data object to service provider 215.

Data collector 810 and data collector 811 may each collect feedback data regarding the transaction. After the transaction is completed, data collector 811 may send feedback to directory service 210 through feedback path 803 or may place feedback in portion of the data object that is readable or writable to service provider 215 and directory service 210. After placing the feedback in the data object, the service provider may then send the data object back to client 205 as part of the transaction.

Similarly, data collector 810 may also collect feedback data regarding the transaction between client 205 and service provider 215. Data collector 810 may then send this feedback data to directory service 210 through feedback path 801. Alternatively, or in addition, data collector 810 may wait until client 205 requests another service location from directory service 210 before sending the feedback data. Data collector 810 may embed the feedback data in the request. In one embodiment, the feedback data is written to a portion of the data object that was returned by service provider 215. The data object is then sent with the request for a service location. In doing this, data collector 810 may also return feedback generated by data collector 811. Multiple data objects may be grouped together and sent with a request thus returning feedback generated by a plurality of data collectors with one request.

Turning to FIG. 9, FIG. 9 includes client 205, directory service 210, service provider 215, and proxy 905. Proxy 905 includes a data collector. The data collector can send feedback to directory service 210 through feedback path 910.

One advantage of the system shown in FIG. 9 is that neither the client nor the service provider needs any modification in order for feedback to be provided to directory service 210. Another advantage is that data can be collected by an unbiased source. That is, instead of directory service 210 relying on feedback provided by client 205 or service provider 215, the directory service 210 can instead obtain feedback from a disinterested third entity, i.e., proxy 905. In one embodiment proxy 905 is implemented as a traffic manager that directs traffic between multiple clients and service providers. A device suitable for implementing proxy 905 in this embodiment is network device 100 as described in conjunction with FIG. 1.

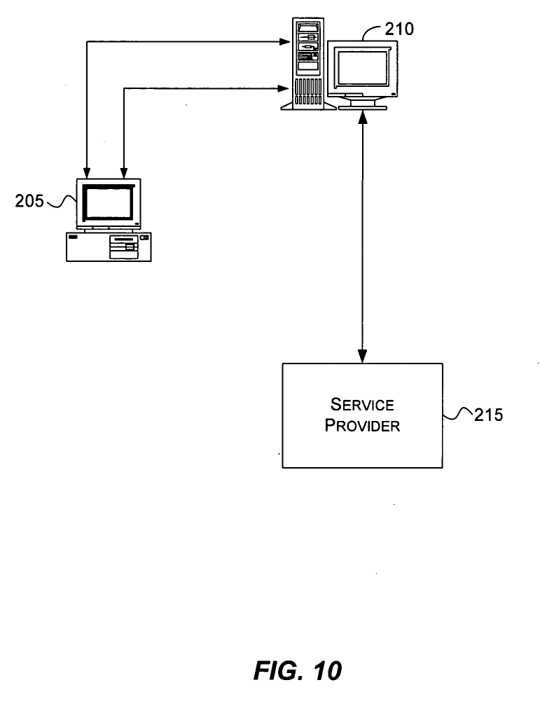

Turning to FIG. 10, FIG. 10 includes a client 205, a directory service 210, and a service provider 215. In FIG. 10, directory service 210 returns service locations to client 205 and acts as a proxy between client 205 and service provider 215. In this embodiment, directory service 210 may collect feedback data with respect to the transaction between service provider 215 and client 205 in addition to any feedback data collected by other data collectors (e.g., data collectors on client 205 and service provider 215 when they exist). In one embodiment of the invention, only directory service 210 collects feedback relating to the transaction. In another embodiment of the invention, one or more of client 205, directory service 210, and service provider 215 collect feedback relating to the transaction.

One advantage of the system shown in FIG. 10 is that neither the client nor the service provider needs any modification in order for feedback to be provided to directory service 210. Another advantage is that data can be collected by an unbiased source. That is, instead of directory service 210 relying on feedback provided by client 205 or service provider 215, the directory service 210 can instead collect feedback based on what it observes from the transaction between client 205 and service provider 215. In one embodiment, directory service 210 is implemented as part of a traffic manager that directs traffic between multiple clients and service providers. A device suitable for implementing directory service 210 in this embodiment is network device 100 as described in conjunction with FIG. 1.

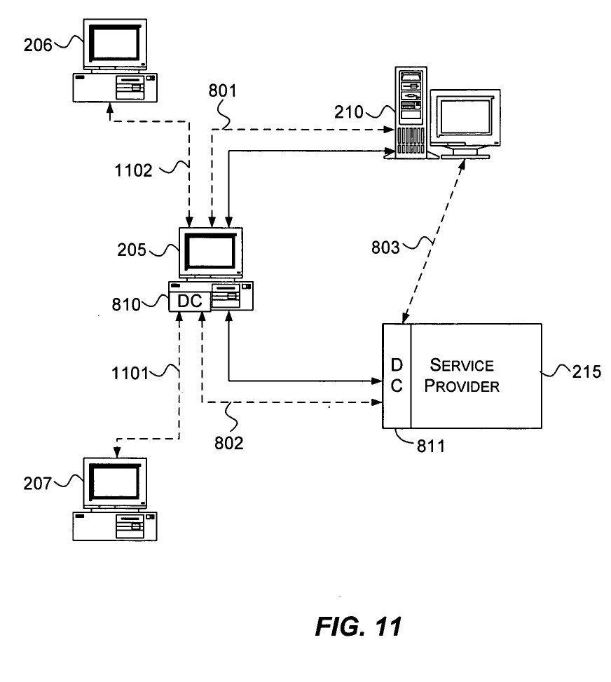

FIG. 11 is a block diagram representing an exemplary system wherein feedback can be shared among clients. The system shown in FIG. 11 operates similarly to that shown in FIG. 8. In the system of FIG. 11, additional feedback paths 1101-1102 are provided to share feedback data among clients 205-207. In FIG. 11, clients 205-207 might all interact with the same directory service 210, each might interact with different directory services, or some combination thereof. The clients 205-207 might interact with the same service providers or with different service providers. In one embodiment of the invention, each of clients 205-207 maintains feedback data in a data repository locally accessible to each client. In sharing feedback data, each of clients 205-207 accesses data from its local data repository and provides the feedback data to the other clients. In another embodiment of the invention, the feedback data is stored on one or more of the clients, on another device accessible to one or more of the clients, or a combination thereof. To obtain feedback data in this embodiment, each of clients 205-207 requests feedback data from the appropriate device or client. Feedback data collected by any of clients 205-207 may also stored on the appropriate device or client. In some embodiments of the invention, one or more of clients 205-207 include a data collector or a feedback data repository. In one embodiment, the directory service 210 provides client 205 with a list of other clients that might have feedback data to share. In this embodiment, client 205 might send a request for clients to the directory service 210. In response, the directory service might return a list of one or more clients, possibly ranked according to a determination by the directory service as to the value of the data of each client. Feedback data relevant to the qualities of client feedback data can be transferred and used by each client and directory service in a manner similar to those described in this application, so that clients perform the role of service provider, providing a service of collecting and sharing feedback data. In such a system, clients having similarities to a requesting client might be considered to be more valuable in their use of their feedback data.

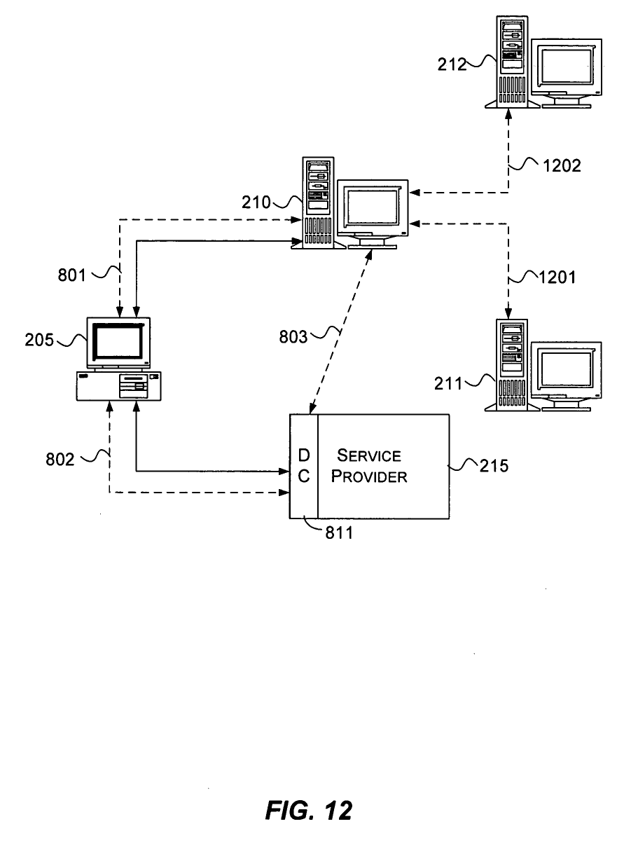

FIG. 12 is a block diagram representing an exemplary system wherein feedback can be shared between directory services. The system shown in FIG. 12 operates similarly to that shown in FIG. 8. In the system of FIG. 12, additional feedback paths 1201-1202 are provided to share feedback data among directory services 210-212. In one embodiment of the invention, each of directory services 210-212 maintains feedback data in a data repository locally accessible to each directory service. In sharing feedback data, each of directory services 210-212 may access data from its respective local data repository and provide the feedback data to the other directory services. In another embodiment of the invention, the feedback data is stored on one or more of the directory services, on another device accessible to one or more of the directory services, or a combination thereof. To obtain feedback data in this embodiment, each of directory services 210-212 requests feedback data from the appropriate device or directory service. Feedback data collected by any of directory services 210-212 may also be stored on the appropriate device or directory service. In some embodiments of the invention, one or more of directory services 210-212 include a data collector or a feedback data repository.

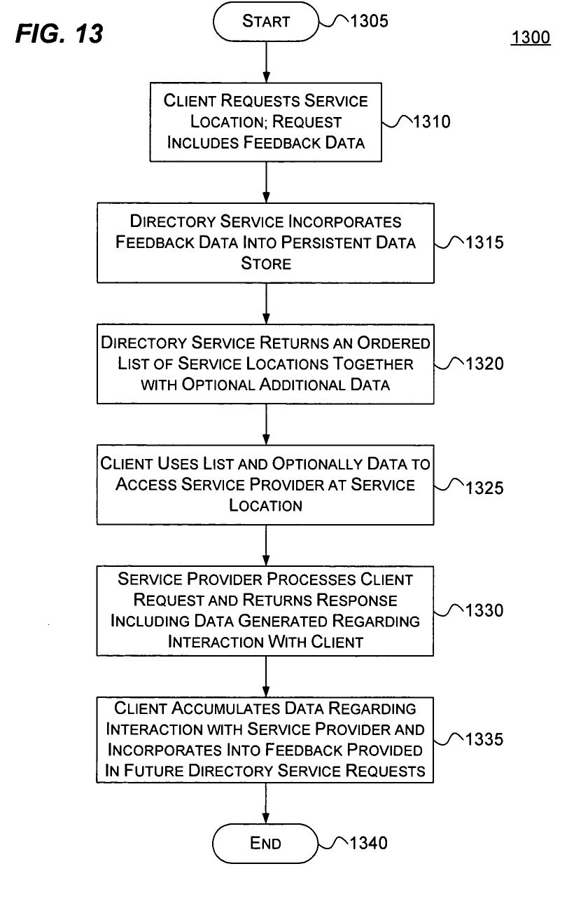

FIG. 13 is a flow diagram illustrating an exemplary process 1300 in which a directory service provides one or more service locations in response to a request for a service location. As illustrated in FIG. 13, the process begins at block 1305.

At block 1310 a client requests a service location. The request may include feedback data related to one or more previous transactions in which the client has engaged with service providers. Such feedback data may be included in a data object as described in conjunction with FIG. 3.

At block 1315, the directory service incorporates any feedback data provided by the client into a data repository accessible by at least the directory service. The data repository may also be accessible by one or more clients or service providers as described previously in conjunction with FIG. 2.

At block 1320, the directory service determines one or more service locations to return to the client based on feedback data, if any is available, as previously described. The directory service then returns the one or more service locations together with optional additional data. Optional additional data may include those things described in conjunction with FIG. 8. In addition, the directory service may also return a data object as described in conjunction with FIG. 3. The one or more service locations returned by the directory service may be ordered or ranked according to client preferences or other criteria sent by or associated with the client.

At block 1325, the client may then select one of the service locations and engage in a transaction with a service provider located at the service location. The client may send the optional additional data or data object to the service provider.

At block 1330, the service provider processes the client request and returns a response including feedback data generated regarding the interaction with the client. The service provider may place this feedback data in the data object passed to it by the client or may generate its own data object to pass back to the client. After placing the feedback in the data object, the service provider may then send the data object back to the client as part of the transaction.

At block 1335, the client accumulates feedback data regarding the transaction between client and the service provider. The client may send this feedback data to the directory service shortly after it is collected or may wait until the client has a need to request another service location from the directory service before sending the feedback data. The client may embed the feedback data in the request. In one embodiment, the feedback data is written to a portion of the data object that was returned by the service provider. The data object is then sent with the request for a service location. In doing this, the client may also return feedback generated by the service provider. Multiple data objects may be grouped together and sent with a request. This allows one request to be used to return feedback generated in relation to transactions with a plurality of service providers.

At block 1340, the process ends. Process 1300 may be executed each time a client seeks to access a service.

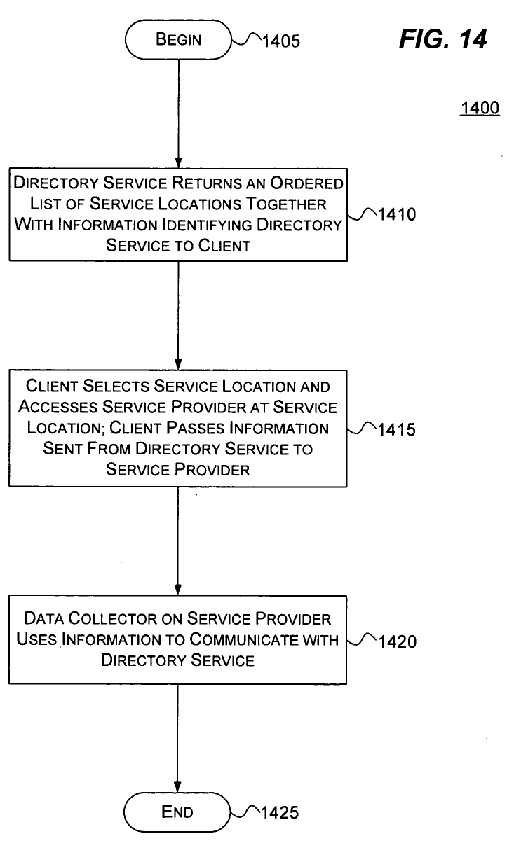

FIG. 14 is a flow diagram illustrating an exemplary process 1400 in which a collector on a service provider sends feedback data directly to a directory service. As illustrated in FIG. 14, the process begins at block 1405.

At block 1410 the directory service returns to the client one or more service locations together with information identifying the directory service. The information identifying the directory service is sent so that the client may send this information to the selected service which can then use the information to send feedback data to the directory service. The one or more service locations returned by the directory service may be ordered or ranked according to client preferences or other criteria sent by or associated with the client.

At block 1415, the client selects a service location and accesses a service provider at the service location. The client sends the information that identifies the directory service to the selected service provider.

At block 1420, a data collector on the service provider uses the information to communicate feedback data to the directory service.

At block 1425, the process ends. Process 1400 may be executed each time a directory service returns one or more service locations to a client.

One exemplary application of the invention is in the area of media content delivery, such as news, movies, or music. The content of the news item can be in one or more of different media types, such as text, audio, and video. In this example, a user at a client device views a list of available topics, subjects, or other groupings. Each grouping has a set of one or more associated providers. When the user selects a grouping for viewing, the client device transmits a request to a directory service. The request includes the designation of the selected topic and a set of user preferences. The directory service also receives feedback data from prior transactions that the user or client has participated in. The directory service can also receive feedback data from other sources, such as other clients. The directory service determines a ranked list of one or more providers, based on the request and feedback data, and sends the list back to the client device. The client device can then automatically initiate a transaction with one of the providers on the list, such as the top ranked provider. The transaction includes requesting the item and receiving it from the provider. The client device then presents the item to the user. Alternatively, the directory service can present a list of providers of the item to the client, and the user can select one for the transaction.

This example can use one or more of several different types of feedback data. Manual client feedback from the requesting client can include feedback designated by the user pertaining to previous transactions. For example, the manual client feedback may answer a question asked about the quality of a content item. Automatic client feedback from the requesting client can include data that the client is aware of, possibly because of the user's actions. The length of time that the user views an item, whether the user saves an item for later viewing, and whether a user sends information about the item to another user are examples of automatic client feedback inferred from the user's actions. The quality of the connection and reception when receiving the item, and age of the item are types of automatic feedback data that can be determined by the client device and used for the process.

Though the feedback data from the user making the request is feedback on previous transactions involving different content items from one or more service providers, client feedback data from other clients can either relate to service providers generally, or it can be feedback on the same item from a service provider. One or more other users may have, for example, performed a transaction and viewed the item minutes, or even seconds earlier, or may even be in a transaction that is not yet completed. Manual or automatic client feedback on this particular item can be transmitted and used by another user, thereby providing valuable feedback on even current news items.

The above specification, examples, and data provide a complete description of the manufacture and use of the composition of the invention. Since many embodiments of the invention can be made without departing from the spirit or scope of the invention, the invention resides in the claims hereinafter appended.

1-43. (canceled)

44. A method for determining a service provider in a computer network, comprising:
performing a transaction, by a client computer, with a first service provider, the first service provider being a server computer;
automatically collecting feedback data pertaining to the transaction;
transmitting, to a directory service, a request for a provider of a second service, the directory service including a UDDI server configured to execute a UDDI protocol;
transmitting, to the directory service, at least a portion of the feedback data from the transaction involving the first service provider; and
receiving, from the directory service, a response based on the second service request, the at least a portion of the feedback data, and the UDDI protocol, wherein the response comprises one or more service locations.

45. The method of claim 44, wherein the feedback data comprises an evaluation of a service provided by the first service provider.

46. The method of claim 44, wherein the feedback data comprises data representing a negative rating of the first service provider.

47. The method of claim 44, wherein the feedback data comprises data representing a positive rating of the first service provider.

48. The method of claim 44, wherein the feedback data comprises a quality of content provided by the first service provider.

49. (canceled)

50. The method of claim 44, further comprising:
receiving, from the client computer, a second feedback data pertaining to a transaction between the client computer and one or more service providers; and
transmitting, to the directory service, the second feedback data, wherein the response is at least in part based on the second feedback data.

51-67. (canceled)

68. The method of claim 44 further comprising automatically selecting, solely by the client computer, from the one or more service locations, a service location based on the at least a portion of feedback data.

69. The method of claim 44, wherein the feedback data comprises connection characteristics.

70. The method of claim 69, wherein the connection characteristics include one or more of measured latency, network path used for a connection, bandwidth, response time, and dropped packets.

71. A method for determining a computer service provider in a network, comprising:
monitoring, in the network, an electronic transaction involving a client computer and a first computer service provider, the first computer service provider configured to provide the client computer with a first service, the network including a directory service device and at least one data collector device;
automatically collecting feedback data by the at least one data collector device, the feedback data pertaining to the electronic transaction;
receiving in the directory service device a service request for a location of one or more computer service providers configured to provide a second service;
transmitting, from the at least one data collector device to the directory service device, at least a portion of the automatically collected feedback data; and
transmitting, from the directory service device, a response based on the service request and the at least a portion of the automatically collected feedback data, wherein the response comprises one or more locations of computer service providers.

72. The method of claim 71, wherein the directory service device includes a UDDI server configured to execute a UDDI protocol.

73. The method of claim 72, wherein the UDDI server executes the UDDI protocol to generate the response comprising the one or more locations of computer service providers.

74. A network apparatus for providing service locations to a client computer, the network apparatus comprising:
a data collector configured to receive feedback data associated with one or more transactions between one or more client computers and one or more computer service providers;
a data repository coupled to the data collector, the data repository including a data storage device for storing the feedback data collected by the data collector;
a UDDI server including a UDDI registry, the UDDI registry including information associated with the one or more computer service providers, the UDDI server configured to execute a UDDI protocol to generate a list of service locations for one or more of the computer service providers in response to a request from the client computer, the list of service locations based at least in part on the feedback data stored in the data repository and the information associated with the computer service providers.

75. The network apparatus of claim 74, wherein the network apparatus is a traffic manager on a network.

76. The network apparatus of claim 74, wherein the feedback data includes computer connection characteristics.

77. The network apparatus of claim 76, wherein the computer connection characteristics include at least one of measured latency and network path used for a connection.

78. The network apparatus of claim 76, wherein the computer connection characteristics include at least one of bandwidth, response time, and dropped packets.
